(19) United States
(12) Patent Application Publication
(10) Pub. No.: US 2002/0129273 A1
(43) Pub. Date: Sep. 12, 2002

(54) Secure content server apparatus and method

(75) Inventor: Jeremy Scott Noonan, Durham, NC (US)

Correspondence Address: LAW OFFICE OF, MARCIA L. DOUBET, 5228 WESTMINSTER LN., FUQUAY-VARINA, NC, 27526, US

(73) Assignee: Nightlight, Inc.

(21) Appl. No.: 09/800,860

(22) Filed: Mar. 7, 2001

(51) Int. Cl. H04L 9/00

(52) U.S. Cl. 713/201

(57) ABSTRACT

Methods, systems, computer program products, and methods of doing business by securely serving content to requesters in a computer networking environment. All content to be served is stored on read-only media (or, alternatively, on media for which write capability can be disabled). By preventing write access, a number of content substitution security exposures (such as Web site defacing) are avoided. Web pages or Web documents to be served cannot be overwritten with alternative content by hacking into a server device when using the teachings of the present invention. Similarly, files provided for downloading from a site using File Transfer Protocol (“FTP”) cannot be overwritten with alternative content by hackers. In the unlikely event that an overwriting occurs (e.g. when content is copied from the read-only media into system memory for performance reasons, and security of the memory is somehow compromised), the content will self-repair using teachings of the present invention.

### BACKGROUND OF THE INVENTION

1. Field of the Invention

The present invention relates to security in computer networking environments, and deals more particularly with methods, systems, computer program products, and methods of doing business for securely serving content (such as Web pages, files, and so forth) to requesters.

2. Description of the Related Art

Millions of people today use distributed network computing environments on a regular basis, whether in their jobs or for their own personal enjoyment. The public Internet and the subset thereof known as the World Wide Web are the most popular of such networks, but many other networking environments such as corporate intranets and extranets are also widely used. (Hereinafter these networking environments are referred to collectively as “the Web” or, alternatively “the Internet”, for ease of reference.) Many of the nation's (and the world's) businesses and government entities rely heavily on the ability to exchange data and communications electronically using networks, and electronic commerce is rapidly becoming a significant part of the national and world economy. Projections have been made that the number of Internet users in the United States will rise from 1999's 100 million users to over 175 million users by 2003, with the world-wide total exceeding 500 million in that same time period. Electronic commerce sales, estimated at $100 billion in 1999, are expected to reach $1 trillion by 2003.

As this phenomenal growth in networked computing continues, the security of electronic communications remains a significant concern. The Internet was originally designed with the academic and scientific communities in mind, under assumptions that those communities would be working in a cooperative, non-adversarial manner. Security features were therefore not designed into the network infrastructure and its basic supporting communication protocols. When security breaches occur, significant financial losses may result and user confidence is undermined. The Gartner Group has projected that the cost of “cyber crime” will increase 1000 percent between the years 2000 and 2004. (See “With Hacker Attacks on Rise, Simple Precautions Will Go a Long Way”, Dec. 18, 2000, which is available on the Internet at www3.gartner.com.)

Many different types of security threats exist in networked computing environments. These include denial of service attacks, viruses and worms, Trojan horses, masquerading and takeover attacks, and cyber vandalism. In denial of service attacks, targeted servers of a victim site are overwhelmed with incoming data, preventing the servers from servicing legitimate requests. Viruses and worms are executable code, often destructive in nature, that is designed to automatically transmit itself from each infected computer to many other computers (using the electronic address book of each computer to obtain more destination addresses, for example). Trojan horse software performs some function other than its represented function, typically in a malicious manner. In masquerading attacks, the attacker may pretend to be an authorized system user (often through stolen access information or by exploiting security weaknesses in the system) then improperly access system resources. Takeover attacks occur when a malicious computer impersonates a legitimate server, thereby diverting that server's incoming messages to the malicious computer. Cyber vandalism is an electronic equivalent to conventional vandalism, wherein attackers may substitute a site's legitimate content with alternative content supplied by the cyber vandal.

Many of these types of attacks involve storing malicious code on the victim computer. For example, in a type of denial of service attack known as “distributed denial of service”, code is placed onto a system to cause that system to function as a “master” and code is also placed onto other systems to cause them to function as “slaves”. When the master code is activated, it sends messages to trigger the slaves, which typically act in a concerted manner to flood a legitimate server with incoming traffic and thereby deny service to its intended users. Trojan horse software also requires storing malicious code on the victim computer. As another example, cyber vandalism (also referred to as “Web site defacing”) occurs when the content to be served from a victim site is overwritten with the vandal's alternative content. Some cyber vandalism attacks are motivated by political or activist agendas, and thus such attacks are sometimes referred to as “hacktivism”. For example, during the November 2000 presidential election in the United States, the Web site of the Republican National Committee was vandalized, and that site's promotional information for the Republican candidate was replaced with promotional information for the Democratic opponent. A similar incident occurred in Sweden several years earlier, during a Swedish general election, where the Web site of the country's right-wing political party was replaced with links to the left-wing party's home page. Sites of the U.S. Navy and Department of Transportation have also been defaced. It has been estimated that several hundred site defacing incidents occur every month. (See “Script kiddies: The Net's cybergangs”, Jul. 12, 2000, published at www.zdnet.com.) Repairing a Web site after cyber vandalism may take a relatively short amount of time in some cases, once the vandalism is detected (although the Republican National Committee site was out of service for half a day's time at a very critical point). However, the damage may also be more severe. Suppose, for example, that an on-line bill payment site is hacked to substitute an imposter's bank account information, and that consumers then rely on this substituted information when making payments. The results of this type of cyber vandalism might be quite expensive, in terms of repairing the direct financial damage as well as in lost consumer confidence and, often, a seriously tarnished image for the victim site. Or, a site used to download code to requesters using the File Transfer Protocol (“FTP”) might be hacked to substitute malicious code, and the unsuspecting users might then download and execute this code with serious negative results.

Many different types of security procedures are in place by businesses and government entities to avoid security breaches. However, these solutions are complex and difficult to maintain. Furthermore, hackers the world over go to great lengths to detect weaknesses in existing security procedures. As security experts develop patches for detected weaknesses, the hackers search for ways to exploit other weaknesses.

In view of the existing security exposures in computer networking environments and the drawbacks of existing solutions, what is needed is an improved technique for ensuring that content served to requesters is secure.

### SUMMARY OF THE INVENTION

An object of the present invention is to provide an improved technique for ensuring that content served to requesters in computer networking environments is secure and unaltered from its intended content.

Another object of the present invention is to provide this technique by serving content only from read-only media (or, alternatively, from write-protected media).

Yet another object of the present invention is to provide a technique for securely serving content to requesters that is self-repairing in the event of a security breach.

Still another object of the present invention is to provide a technique for securely serving content to requesters that enables continuous service during a planned content revision.

Other objects and advantages of the present invention will be set forth in part in the description and in the drawings which follow and, in part, will be obvious from the description or may be learned by practice of the invention.

The present invention provides methods, systems, computer program products, and methods of doing business by securely serving content to requesters in a computer networking environment. All content to be served is stored on read-only media (or, alternatively, on media for which write capability can be disabled). By preventing write access, a number of security exposures are avoided. Web pages or Web documents to be served cannot be overwritten with alternative content by hacking into a server device when using the teachings of the present invention. Similarly, files provided for downloading from an FTP site cannot be overwritten with alternative content by hackers. In the unlikely event that an overwriting occurs (e.g. when content is copied from the read-only media into system memory, and security of the memory is somehow compromised), the content will self-repair using teachings of the present invention.

The present invention will now be described with reference to the following drawings, in which like reference numbers denote the same element throughout.

### BRIEF DESCRIPTION OF THE DRAWINGS

FIG. 1 is a block diagram of a computer networking environment in which the present invention may be practiced;

FIG. 2 is a block diagram of internal components of the secure server of the present invention;

FIG. 3 provides a flowchart depicting logic which may be used in implementing preferred embodiments of the present invention;

FIG. 4 illustrates sample configuration parameters and values thereof that may be used by an implementation of the present invention;

FIGS. 5A and 5B illustrate sample Web page documents that may be served to a requester, and are used in describing a preferred embodiment of the present invention; and

FIG. 6 illustrates an alternative computer networking environment in which the present invention may be practiced, according to an optional aspect of the present invention.

### DESCRIPTION OF PREFERRED EMBODIMENTS

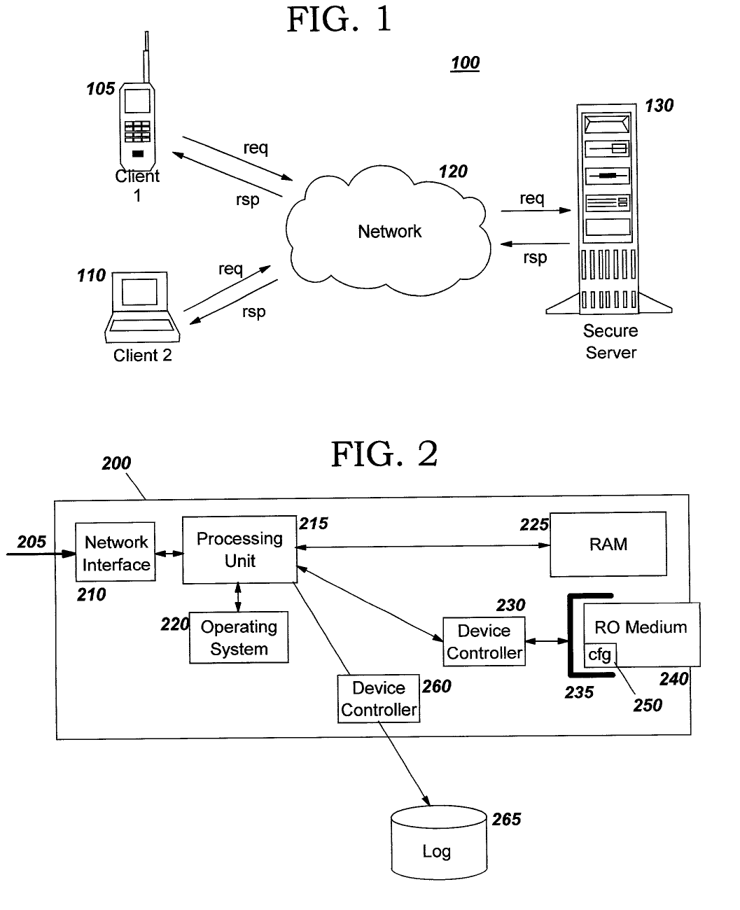

FIG. 1 illustrates a representative computer networking environment 100 in which the present invention may be practiced. One or more client devices, illustrated as a Web-enabled cellular phone 105 and a laptop computer 110, communicate with the secure server 130 of the present invention by exchanging request and response messages through the Internet 120 (or an alternative network). When the secure server 130 is functioning as a Web content server, the request and response messages are typically Hypertext Transfer Protocol (“HTTP”) messages. When the secure server 130 is functioning as an FTP server (or an equivalent server from which content is downloaded upon request), the request and response message use FTP (or an analogous protocol) instead. Note, however, that the present invention is not limited to use of any particular protocol nor to use with any particular type of content: the techniques disclosed herein may be used with any similar networking protocol, and without regard to the type of content being served.

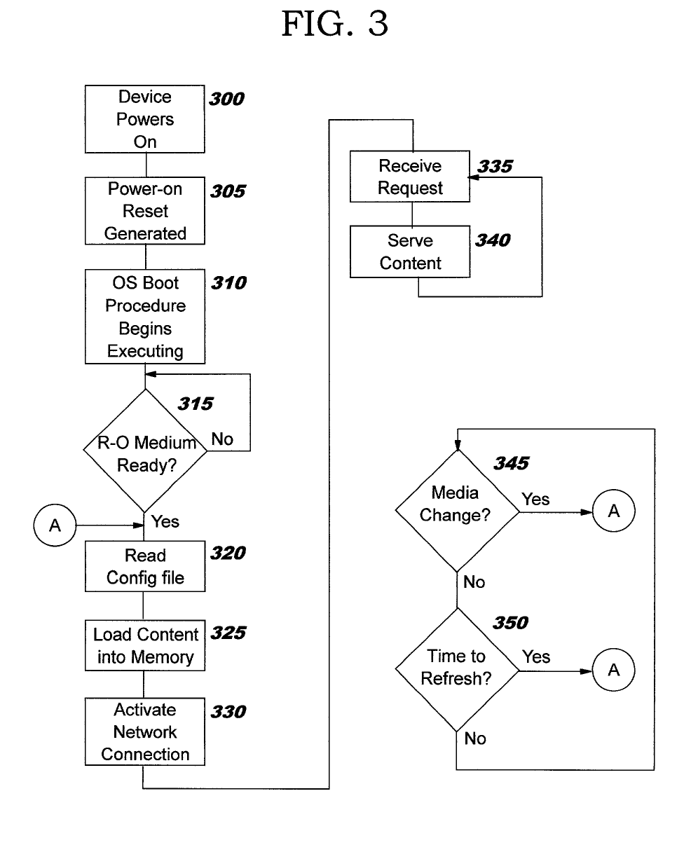

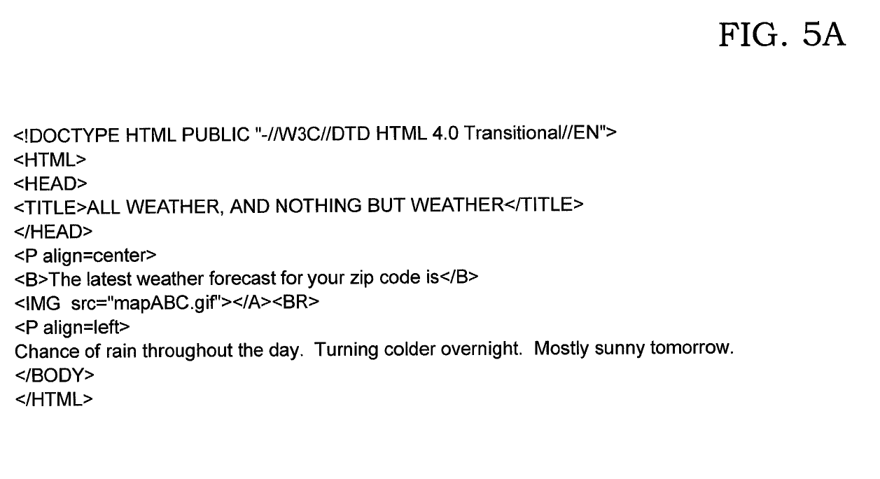

FIG. 2 depicts representative internal components 200 of the secure server 130. A processing unit 215 performs operations for the server device, and coordinates interactions of other components. One or more network interfaces 210 are provided, in order to establish network connections 205 with clients. Representative network interfaces include adapter cards for 10 Megabit Ethernet, 100 Megabit Ethernet, token ring, fiber optics, and so forth. Network connections with clients may use wireline networks and/or wireless networks, using techniques which are well known in the art and which will not be described in detail herein. An operating system 220 contains executable instructions that are used, inter alia, to boot the server device 130 (instructing it, for example, to read initial configuration information 250 from a read-only medium 240). The operating system must be adapted to ensure that the secure server does not run with “root” authority (or an analogous authority which includes write permissions). Techniques for adapting an operating system in this manner are well known in the art. One or more types of updateable internal storage, illustrated in FIG. 2 as random access memory (“RAM”) 225, may be provided as a performance optimization, as will be described in more detail below. At least one read-only medium 240 is used. Representative types of read-only media include commercially-available CD-ROM, DVD, and Zip® disks which are either read-only or which can be write-protected. (“Zip” is a registered trademark of Iomega Corporation.) The read-only media are preferably removable components, and are operably connected to the processing unit 215 by insertion into a media-specific hardware drive 235 (which typically interacts with processing unit 215 through a device-specific driver or controller 230). Configuration information 250 to be used in operating the secure server 130 may optionally be stored on each read-only medium. (Alternatively, default configuration values may be used, as described below with reference to FIG. 4.) Optionally, information may be stored in an external repository 265 (such as a disk drive) when using the present invention, for example to store information about operational conditions in a log or trace file. Note that this optional feature is shown in FIG. 2 as a one-way communication path from the processing unit 215, and also uses a device-specific controller 260. A limited number of other types of external interfaces, not shown in FIG. 2, may optionally be supported. These include serial port connections and Universal Serial Bus (“USB”) connections. (These connections may be used to write new data to the server device, if desired; however, writing from the network connection is not allowed, as is described herein.)

The software used to provide the functionality of secure server 130 (i.e. software for operating a Web server, or an FTP server, etc.) is preferably a commercially-available server implementation such as a Netscape Enterprise server from Netscape Communications Corporation, an Internet Information Server from Microsoft Corporation, or an Apache HTTP server designed by the Apache HTTP Server Project. The operating system 220 may be a commercially-available operating system, such as a Unix or Linux implementation (which may be obtained from a number of vendors). Alternatively, a specially-customized operating system implementing the teachings described herein may be provided. (In addition, a specially-customized server implementation may be provided for use with the present invention if desired.)

The present invention provides improved techniques for securely serving content to requesters. As will now be described, the disclosed techniques provide for a server which is virtually immune to content substitution attacks. Hackers cannot gain access to the site's content to change what will be served to requesters, and therefore cannot deface Web sites which are supported using the teachings disclosed herein. Because the content being served cannot be altered, distributed denial of service attacks cannot be propagated from a secure server which makes use of the techniques of the present invention. As an additional benefit, it is not necessary to perform time-consuming back-up procedures for content that is being served: because the media is read-only, the media itself (or a copy thereof) serves as its own backup. Complex and expensive retention and recovery procedures are therefore unnecessary as well. In an optional embodiment where the secure server supports more than one read-only medium concurrently, site availability does not need to be disrupted during planned content upgrades or revisions: instead, a “hot swap” process is used whereby already-received requests are served from the existing medium (i.e. the medium being revised) while support for newly-arriving requests is migrated to the new medium (i.e. the medium having the replacement content).

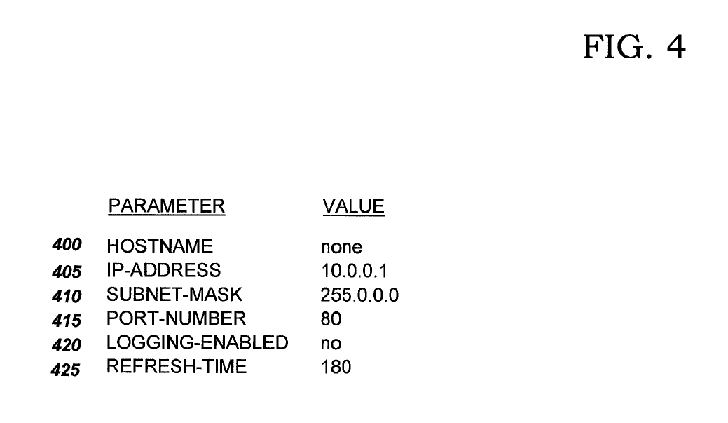

Many vulnerabilities in prior art servers occur because of the complex capabilities of the operating systems. According to the present invention, however, the operating system capabilities are limited to only what is necessary for the particular content being served. For example, if the server is a Web server, then it only responds to Web content requests; if it is an FTP server, it only responds to FTP requests. Information used to configure the operating system, and thereby limit its capabilities appropriately, is preferably stored on read-only media along with the content being served (as shown at 250 in FIG. 2). This approach provides a virtually tamper-proof solution, and also reduces maintenance requirements and demands on system administrator personnel. Use of the configuration file information is described in more detail below, with reference to Block 320 of FIG. 3.

Logic depicting operation of preferred embodiments is shown in FIG. 3. This logic is preferably implemented in software, and may be stored as computer-usable instructions on one or more computer-usable media. When secure server 130 of FIG. 1 is powered on (Block 300), a hardware-initiated power-on reset signal is generated (Block 305), using techniques of the prior art. In response to this signal, the operating system boot procedure (stored in component 220 of FIG. 2) begins to execute. This boot procedure is preferably adapted to read initial configuration information from the read-only medium which is operably connected to the secure server. Block 315 therefore checks to see if the read-only medium is ready. If not, then processing waits; otherwise, processing continues to Block 320 which reads the information from the configuration file on the read-only medium. In preferred embodiments, the configuration information is stored in a file of a predetermined name (or, equivalently, at a predetermined location) on the read-only medium, and is specified using either values of predetermined parameter names or fixed ordering of values.

A sample set of default configuration values that may be used by an implementation of the present invention is illustrated in FIG. 4. Note that these are merely illustrative parameters and parameter values: additional or different parameters may be used without deviating from the inventive concepts of the present invention. If the read-only medium contains a configuration file, then these defaults are overridden at run-time with the corresponding values supplied in the configuration file. A host name 400 may optionally be specified, which may have the form “www.domain-name.com”. When provided, this value is preferably used on outgoing response messages as part of the information sent to clients requesting content. An Internet Protocol (“IP”) address 405 to be used for identifying the secure server in the network and routing messages to it is a required parameter. A default value of “10.0.0.1” is shown in FIG. 4, which enables the secure server to establish an operable network connection to a device on a private internal network (for example, for verification that the network interface is operable). An actual globally-unique IP address may be provided in the configuration file, where this value has been obtained using prior art techniques and is hard-coded in the configuration file. Or, the secure server may request its IP address dynamically, for example by contacting a Dynamic Host Configuration Protocol (“DHCP”) or Boot Protocol (“BootP”) server using known techniques. A subnet mask 410 may be provided, which is used when configuring the network interface. A default subnet value of “255.0.0.0” is shown in FIG. 4. A port number 415 is also a required value, and identifies the well-known or ephemeral port on which the secure server will listen for incoming request messages. For Web requests using HTTP, port number 80 is typically used, whereas port number 21 is typically used for FTP messages.

Optionally, a single secure server of the present invention may be used for serving content for more than one destination IP address. For example, the server may have more than one network adapter, where each adapter has its own unique IP address. In this case, the configuration file preferably contains separate entries for each such IP address, as well as corresponding port numbers and subnet masks for each IP address.

As stated earlier, an implementation of the present invention may optionally be enabled for writing information about various operational conditions to an external repository (such as log file 265 in FIG. 2). A configuration parameter such as “logging enabled” 420 may then be used to selectively activate this logging function. Preferably, the default logging value is “no”. A Uniform Resource Locator (“URL”) may be specified as a configuration option, where this URL identifies the location to be used to identify the external repository. A further option, also mentioned previously in terms of self-repairing content, is a periodic refresh. This option may be implemented when content is copied from its read-only medium to faster storage such as RAM 225, and the content serving operation then uses that updateable storage. Because a clever hacker might possibly find a way to compromise the security of the updateable storage, an automatic refresh of its contents from the read-only medium limits the resulting outage time and also optimizes the recovery process. Preferably, the refresh time is specified using seconds as the unit of time. Thus, the sample default value shown at 425 of FIG. 3 specifies that a refresh is to occur every 3 minutes. The refresh value should be set such that it does not cause system thrashing; the particular value to be used will be system-dependent.

The values obtained from the configuration file are used to configure the system, in accordance with known configuration techniques. As shown at Block 325, the content from the read-only medium may then optionally be loaded into updateable system memory. (While the updateable memory is illustrated in FIG. 2 as being RAM 225, alternatives include SRAM, DRAM, EEPROM, and so forth.) Loading content into memory provides for better performance, as content can typically be served more quickly from memory than from a read-only medium. Several different strategies may be used for this content loading operation. Typically, the amount of RAM available in a server will exceed the storage capacity of a CD-ROM (which in today's technology normally holds approximately 640 megabytes of data). Thus, the entire data content of the read-only medium may be copied to system memory. Or, if system memory is limited or is otherwise incapable of storing the entire content, then paging or caching algorithms of the type which are commonly known in the art (such as a “least recently used”, or “LRU”, algorithm) may be employed to determine which content should be stored in system memory (and which content should be replaced during on-going operations). Furthermore, when new content is being loaded into system memory after some initial content has already been stored therein (such as when control returns to Block 320 after a positive result from the test in Block 345), then the new content may either overwrite the existing content or may be appended thereto, as desired in a particular implementation of the present invention. In embodiments which support serving content from multiple read-only media concurrently, then system memory may be logically partitioned, if desired, such that content loaded from one medium does not overwrite content loaded from another medium. (It will be obvious to one of ordinary skill in the art how the logic shown in FIG. 3 may be adapted to support these various strategies for content loading.)

At Block 330, the network connection from the secure server is activated. The server then begins receiving incoming requests (Block 335), and serving the requested content (Block 340). Because the content is stored on read-only media, it cannot be maliciously altered, as stated earlier. This provides a very powerful defense to content substitution attacks, with very little added complexity or expense to the implementing server site. This process of receiving requests and serving the requested content then repeats for each successive incoming request.

Preferably, a multi-threaded server implementation is used whereby one or more threads are devoted to handling content requests, and another thread monitors the device controllers of the read-only media drives to see if the read-only medium has changed (shown in Block 345). When a change is detected, the thread detecting the change notifies the main processing thread (e.g. by issuing an interrupt). This notification preferably invokes the processing of Block 320 to obtain the configuration information from this new medium, and to thereby re-initialize the server (once currently-active network connections have been serviced). In this manner, if the configuration has somehow been corrupted during execution, a valid configuration is easily and efficiently restored. On these subsequent iterations through the logic of Blocks 320 through 330, the content from the new medium may then optionally be loaded into system memory, as has been described earlier with reference to Block 325, and the network connection may be re-established. As an alternative, a test may be added to the logic of FIG. 3 for use in these subsequent iterations which checks to see if the new configuration parameters are still valid with the existing network connection; if so, then Block 330 may be bypassed. Similarly, the processing of Block 325 might be bypassed (for example, by computing a hash value over the already-stored content in memory and over the content of the new read-only medium, and then comparing these hash values to determine if the processing overhead of the re-loading operation is necessary).

The thread used to check for a media change in Block 345 may also be used to check whether the optional periodic refreshing is needed (Block 350). (Alternatively, separate threads may be used for each of these checking processes.) When periodic refreshing is implemented, a count-down timer or other equivalent technique is preferably used to determine when the refresh is to be performed. If a refresh is triggered, the processing of Block 320 is invoked to re-initialize the server and to re-load the system memory (as described with reference to detection of a media change by Block 345). In this manner, any content corruption that may have occurred to system memory is automatically and efficiently repaired.

In an optional enhancement of this refresh technique, system memory may be re-loaded selectively. For example, statistics may be gathered about which pages of a Web server are most often being served, and those pages might then be refreshed while other less-often used content remains only on the read-only medium. Or, it might be desired to maintain the home page (and perhaps several additional more popular pages) for a particular site in memory for faster loading. This type of information may optimally be provided through use of additional configuration parameters, which may name or otherwise identify specific areas of a particular read-only medium for refreshing. (These techniques may also be used when initially loading the system memory on a first iteration of the logic in FIG. 3, if desired.)

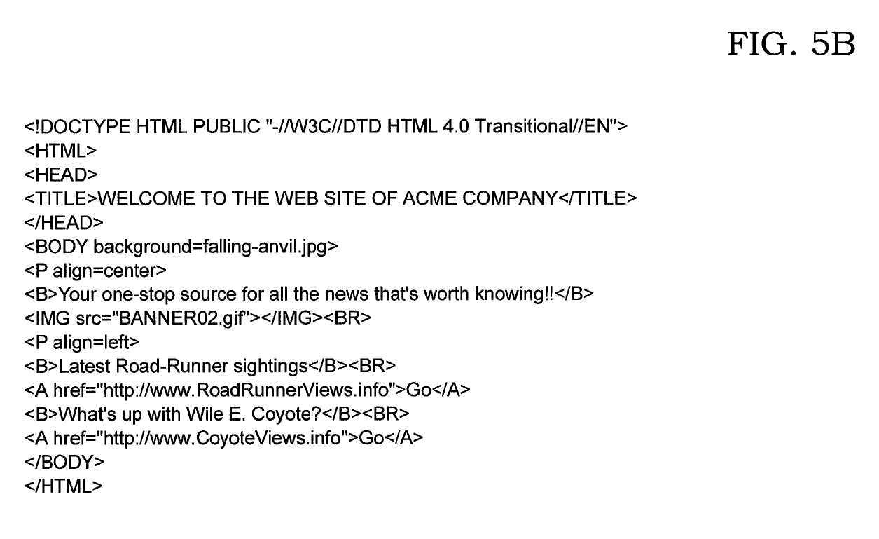

Referring now to FIGS. 5A and 5B, simple examples of content to be served from a Web server are shown. The present invention may be used advantageously with any type of content that is static in nature, such as executable code intended for downloading from an FTP server, files stored on a database server, and Web pages such as that illustrated in FIGS. 5A and 5B. The example in FIG. 5A represents a Web page providing a pre-generated weather forecast (that may be selected, for example, using information such as a zip code from an incoming HTTP GET message). The example in FIG. 5B also represents a static Web page, but one which is a framework for content and contains URLs with which the receiving client can request additional information (from this server or perhaps from a different server). In the case of “static” content that changes periodically, such as the weather forecast example in FIG. 5A, the revised content can be made available for serving simply by replacing the read-only medium, as has been discussed.

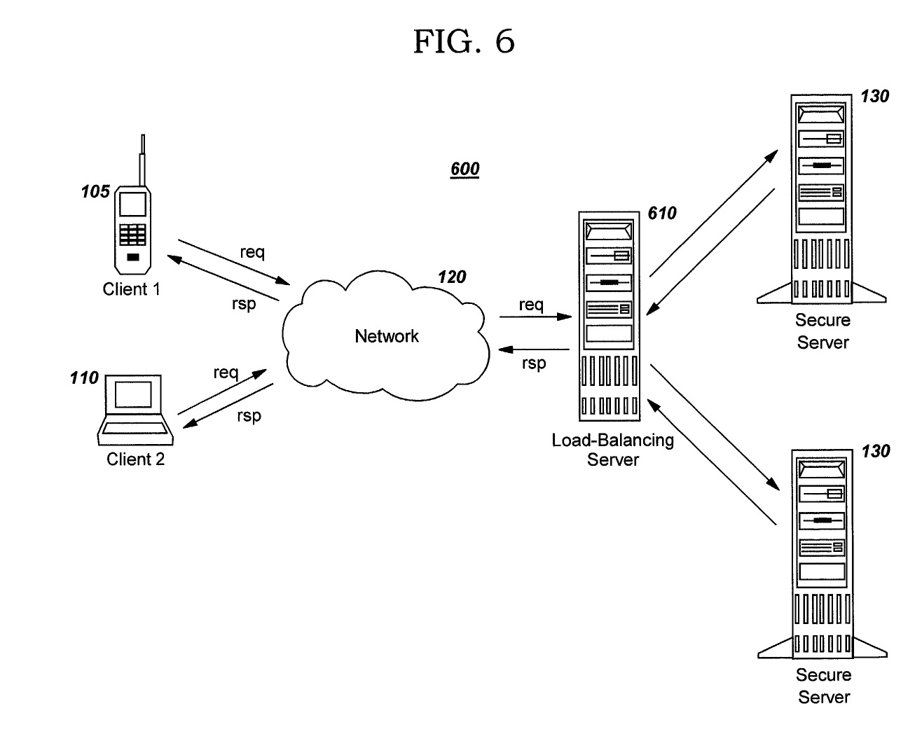

FIG. 6 illustrates a computer networking environment 600 in which the present invention may be practiced, where this networking environment is a more complex alternative to that depicted to FIG. 1. Multiple secure servers 130 are illustrated, where these servers are front-ended by a load-balancing server 610. While only two secure servers are shown, many more than two may be present in a complex networking environment. Furthermore, the teachings of the present invention may be used for securing the content to be served from backend servers, such as database servers (not shown). For example, the present invention may be used to serve content for on-line merchandise catalogs. In this case, the secure database server contains information about the merchandise, where the user at the client device selectively requests information about particular items of merchandise to be delivered to her client device.

As has been demonstrated, the present invention provides advantageous techniques for securely serving content to requesters, which avoids a number of security exposures existing in the prior art.

Use of the present invention enables providing new methods of doing business. For example, a service provider making use of the teachings disclosed herein might require payment of an additional monthly fee by virtue of the increased security and tamper resistance that can be offered to customers whose content is being served.

The present invention may also be used advantageously by home computer users. For example, users may host their own Web pages with a secure server of the type described herein, perhaps connecting that secure server to the Internet with a cable modem or Digital Subscriber Line (“DSL”) connection. This technique avoids the need for the user's personal computer to remain connected to the Internet, making the information stored on that computer less vulnerable to attack, and protects the content being served as the user's Web page(s) as well.

While preferred embodiments of the present invention have been described, additional variations and modifications in those embodiments may occur to those skilled in the art once they learn of the basic inventive concepts. Therefore, it is intended that the appended claims shall be construed to include both preferred embodiments and all such variations and modifications as fall within the spirit and scope of the invention.

What is claimed is:

1. A secure server for securely serving content to requesters in a computer networking environment, comprising:
means for accessing one or more read-only media or write-protected media by the secure server, wherein all content to be served is embodied on the read-only media or write-protected media; and
means for serving the content to the requesters over the computer networking environment.

2. The secure server according to claim 1, further comprising means for disabling write access to the read-only media or write-protected media in an operating system of the secure server.

3. The secure server according to claim 1, wherein the read-only media or write-protected media contains values used to configure the secure server.

4. The secure server according to claim 3, wherein the values include an Internet Protocol (“IP”) address to be used for the secure server.

5. The secure server according to claim 3, wherein the values include an Internet Protocol (“IP”) address and a port number to be used for the secure server.

6. The secure server according to claim 3, wherein the values include a plurality of pairs of Internet Protocol (“IP”) addresses and port numbers, each pair of which is to be used for a different network adapter of the secure server.

7. The secure server according to claim 1, wherein the secure server is a Web server and the content to be served is Web documents.

8. The secure server according to claim 1, wherein the secure server is a File Transfer Protocol (“FTP”) server and the content to be served is downloadable files.

9. The secure server according to claim 1, wherein the means for serving the content further comprises:
means for receiving requests from clients for content;
means for locating the requested content on the read-only media or write-protected media; and
means for serving the located content to the requesting clients.

10. The secure server according to claim 9, further comprising:
means for detecting availability of a different read-only media or write-protected media; and
wherein the means for locating the requested content and the means for serving the located content then uses the different read-only media or write-protected media for requests received after the detection.

11. The secure server according to claim 1, further comprising means for loading at least a subset of the content to be served from the read-only media or write-protected media into updateable system memory of the secure server, and wherein the means for serving the content to the requesters serves the subset of the content from the updateable system memory.

12. The secure server according to claim 11, further comprising means for repeating the loading upon expiration of a refresh timer.

13. The secure server according to claim 12, wherein a value for the refresh timer is specified as a configuration value on the read-only media or write-protected media.

14. A method of securely serving content to requesters in a computer networking environment by embodying all content to be served on one or more read-only media or write-protected media accessible by a secure server which serves the content to the requesters.

15. A method of securely serving content to requesters in a computer networking environment, comprising steps of:
receiving, over the computer networking environment, a request from a client for content at a secure server;
accessing one or more read-only media or write-protected media by the secure server, wherein all content to be served is embodied on the read-only media or write-protected media;
locating the requested content on the read-only media or write-protected media; and
serving the located content to the requesting client over the computer networking environment.

16. The method according to claim 15, further comprising the step of loading at least a subset of the content to be served from the read-only media or write-protected media into updateable system memory of the secure server, and wherein:
the locating step may locate the requested content on the read-only media or write-protected media, if the requested content is not in the loaded subset, or in the updateable system memory otherwise; and
the step of serving the located content to the requesting client serves the located content from the read-only media or write-protected media or from the updateable system memory, as appropriate.

17. A computer program product for securely serving content to requesters in a computer networking environment, the computer program product embodied on one or more computer-readable media and comprising:
computer-readable program code means for receiving, over the computer networking environment, a request from a client for content at a secure server;
computer-readable program code means for accessing one or more read-only media or write-protected media by the secure server, wherein all content to be served is embodied on the read-only media or write-protected media;
computer-readable program code means for locating the requested content on the read-only media or write-protected media; and
computer-readable program code means for serving the located content to the requesting client over the computer networking environment.

18. The computer program product according to claim 17, further comprising computer-readable program code means for loading at least a subset of the content to be served from the read-only media or write-protected media into updateable system memory of the secure server, and wherein:
the computer-readable program code means for locating may locate the requested content on the read-only media or write-protected media, if the requested content is not in the loaded subset, or in the updateable system memory otherwise; and
the computer-readable program code means for serving the located content to the requesting client serves the located content from the read-only media or write-protected media or from the updateable system memory, as appropriate.

19. A method of doing business by securely serving content to requesters in a network computing environment, comprising:
providing hosting services for content to be served to requesters;
ensuring that the content to be served cannot be altered from its intended content by embodying the content on read-only media or write-protected media;
receiving requests for the content;
locating the requested content on the read-only media or write-protected media; and
serving the located content.
